(19) United States
(12) Patent Application Publication
(10) Pub. No.: US 2002/0107331 A1
(43) Pub. Date: Aug. 8, 2002

(54) Powders of fluorine-containing polymers having a hydrophilic surface and a method for their preparation

(76) Inventors: Amir James Attar, Raleigh, NC (US); Kevin G. Nelson, West Pittston, PA (US)

Correspondence Address: Bernard J. Graves, Jr., Esq., KILPATRICK STOCKTON LLP, 3500 One First Union Center, 301 South College Street, Charlotte, NC, 28202-6001, US

(21) Appl. No.: 09/734,376

(22) Filed: Dec. 11, 2000

(51) Int. Cl. C08F 114/18

(52) U.S. Cl. 525/326.2; 525/366; 524/544

(57) ABSTRACT

The present invention provides fluoropolymer powders having a diameter of from about 0.05 to about 200 microns, said powders having pendant hydrophilic groups and olefinic unsaturation. The powders are useful in applications which require a hydrophilic form of a fluropolymer powder such as poly(tetrafluoroethylene), such as a binder component in inks and coatings, or as components for paste extrusion or as components of composite materials.

### FIELD OF THE INVENTION

This invention belongs to the field of organic chemistry. In particular, it relates to a method for etching or modifying the surface of various fluoropolymers to provide a modified fluoropolymer particle having a hydrophilic surface.

### BACKGROUND OF THE INVENTION

Fluoropolymers are produced as powders by the polymerization of monomers like tetrafluoroethylene, (TFE). The polymers are used as:

1. Powder, e.g. in suspensions,

2. Sintered solid, and,

3. Composites where the polymer is filled with other materials like graphite, glass, molybdenum sulfide, etc.

Fluorine-containing polymers (FCP's or “fluoropolymers”) are in general very inert chemically, hydrophobic and have a relatively very high melting temperature and thermal stability. Consequently, special techniques are required to make parts or films out of FCP's. In general, specialized techniques are needed to manufacture products from FCP's. There are many applications which use or can use FCP's; however, the processing costs or the inability to process FCP's altogether often hampers the development of such applications in a cost-competitive way.

One way to overcome some of the difficulties associated with processing FCP and making products from them is by modifying their surfaces. The myriad of processes for modifying the surfaces of solids are referred to as etching. The processes used to modify the surface of FCP may be divided to two main categories:

1. Etching while the polymer is immersed in a liquid solution, and,

2. Etching while the polymer surface is exposed to gamma radiation, to UV light, laser or electron beams, etc. while the gaseous environment around it is controlled.

Films and large FCP parts are routinely etched by techniques of Type 1 or Type 2. However, powders were never etched effectively by either technique despite numerous attempts to etch powders in the last 40-50 years. Etching powders using beams-based techniques of Type 2 is expected to be practically impossible since such beams travel in straight lines and homogeneous exposure of the surface of micro powders to beams will be non practical. When micro powders are exposed to solutions, they tend to clump and thus they can not be etched since the solution and its active ingredients can not reach the surfaces of the particles inside the clump. Thus, whatever etching of the fluoropolymer occurs in such circumstances, does so on only a portion of the particle and, in any event, is generally impeded by the formation of large agglomerated masses of fluoropolymer material that are not etched or not etched uniformly.

### SUMMARY OF INVENTION

A new class of materials is described and a process for making them. These materials are powders comprising a core of fluorine-containing polymers and pendant hydrophilic groups. The hydrophilic pendant groups include variable amounts of hydroxyl, carboxyls, carbonyls, epoxides, olefinic and other functional groups. Such powders flow freely and are easily wettable even by water. Many of these suspensions are stable. Powders of such a structure are useful in coatings of metals, in inks, in formulations of composites and in many other applications.

Powders with such a structure can be prepared by modifying the surface of micro powders of fluorine-containing polymers such as poly(tetrafluoroethylene), (PTFE). These processes are referred to as “etching”. The etching processes comprise suspending the micro-powder of the FCP in a suitable solvent in the presence of certain surface-active materials at the right concentration, with or without vacuum, while stirring the mixture vigorously. The surfactant has to be able to act as such in a polar solvent. Vigorous mechanical stirring helps desegregate the powder and create the suspension. The etching reagent is preferably sodium naphthalene, NANAP, a complex or adduct of elementary sodium and naphthalene. While in most cases, surfactant alone is effective in creating a stable suspension of the fluoropolymer particles, in a preferred embodiment, we have found that the simultaneous use of vacuum and a surfactant is effective in helping the particles desegregate and thus be amenable for etching by the NANAP. The concentration of the surfactant has to be controlled to permit the creation of micelles in the media with an FCP particle in their center, while allowing the etchant to penetrate the micelle wall and etch the polymer surface.

The crudely etched powder tends to adsorb the naphthalene and the fluoro-naphthalene formed in the reaction. These contaminants and others may be removed by solvent extraction, by steam distillation or by heating the etched powder in boiling water while blowing air through it.

### DETAILED DESCRIPTION OF THE INVENTION

In a first embodiment, the present invention provides a fluoropolymer particle having a diameter of from about 0.05 micron to 200 microns, said particle having pendant hydrophilic functional groups and/or pendant olefinic and/or acetylenic groups. Due to the nature of the methodology provided herein, the fluoropolymer particles of the present invention are uniformly etched on their surfaces. This was never achieved by other methods. By utilizing the methodology of the present invention, one may obtain a stable aqueous dispersion of such fluoropolymer particles.

These new materials are micro powders comprising a core of fluorine containing polymer and a hydrophilic surface having pendant protic and polar functional groups. The latter may include variable amounts of functional group such as hydroxyls, carboxyls, carbonyls, epoxides and hydroperoxides. These pendant groups also include double bonds, (i.e., olefinic bonds), and acetylenic bonds.

As used herein, the term “fluorine containing polymer” or “fluoropolymer” refers to any polymer which contains covalently-bound fluorine. Typical fluoropolymers include but are not limited to homologues and derivatives of poly(tetrafluoroethylene), fluorinated ethylene-propylene copolymers, tetrafluoroethylene and the like.

Other fluoropolymers include those polymers prepared from perfluorinated α-fluoroolefin monomers containing hydrogen atoms as well as fluorine atoms. The α-fluoroolefin has 2 to 6 carbon atoms. Typical α-fluoroolefins include but are not limited to perfluorinated α-fluoroolefins such as tetrafluoroethylene, hexafluoropropene, perfluorobutene-1, perfluoroisobutene and the like, and hydrogen containing α-fluoroolefins such as trifluoroethylene, vinylidene fluoride, vinyl fluoride, pentafluoropropene and the like, and halogen-containing α-fluoroolefins such as trifluorochloroethylene, 1,1-difluoro-2,2-dischloroethylene, 1,2-difluoro-1,2-dischloroethylene, trifluorobromoethylene and the like, and perfluoroalkoxyethylene polymers.

The etched powders are produced by modifying the surface of powders of FCP. In a preferred embodiment, the modifications are done by treating the micro powder by a polar aprotic solvent which contains the complex sodium naphthalene and a surfactant at a concentration sufficient to effect suspension of the powder. The reaction mixture is quenched with a protic solvent to stop the reaction and the powder is subsequently cleaned by solvent extraction, centrifugation and steam distillation.

The FCP micro powder is suspended in a solvent which can dissolve the etching reagent. Applying vacuum during the wetting process and/or vigorous agitation and a suitable surfactant permits faster micellization of the micro powder. The latter helps in desegregating the particles and keeping each of them in the center of an individual micelle. When controlled amounts of suitable surfactants are used, the particles are separated individually yet the micelle “wall” remains sufficiently porous to allow the etching reagent to penetrate through without significant steric hindrance. Analysis of the magnitude of the surface forces suggests that:

1. Greater amounts of surfactants are needed to suspend larger particles.

2. Too large concentrations of the surfactant reduce the effectiveness of the etching process and its kinetics, thus, an optimal concentration of surfactant exist for each particle size distribution, solvent and surfactant.

3. For the most part, increasing the surfactant concentration increases the parasitic consumption of the reagent by secondary chemical processes.

4. The stability of the suspension depends drastically on the solvent-surfactant critical micellization temperature and whether the actual temperature is below or above it.

In a further embodiment, there is provided methodology for cleaning the etched FCP so prepared. The micro powder may have specific geometric surface area of the order of 1-20 m²/gm. Consequently, the etched powder retains on its surface large amounts of impurities from the reaction media. The most effective methods for cleaning the powder are:

1. Solvent extraction.

2. Steam distillation,

3. Recrystalization, and,

4. Boiling the aqueous slurry of the powder while blowing air through it and mixing it vigorously.

The availability of etched FCP powders will open the door for a variety of new applications. These applications may be divided into two classes:

1. Utilization as a dry powder, and,

2. Utilization as a suspension in water or in a solvent.

The main properties of the etched powder which permit novel processing methods and novel products are:

A. The etched powder can be easily slurried in water and other solvents even without vigorous agitation and/or a surfactant.

B. The etched powder forms a stable aqueous slurry in water and in other solvents even when no surface active agent is used. (At least for particles smaller than nominally 14-16 microns).

C. The etched powder can be easily glued to surfaces.

D. The etched powder flows freely and retains little or no static charges.

E. The etched powder lends itself to applications which require stable hydrophilic powder since the surface oxygen functionalities are stable below about 180° C.

F. The etched powder can be easily suspended in liophilic solvents to form lubricants etc.

G. The magnitude of volatile loss depends of coarse on the degree of etching applied but it varies in the range of 0.2 to 8% by weight.

H. The etch powder can be mixed easily and uniformly with powders of other polymers and/or fillers to produce upon sintering or curing composite materials with properties similar to FPC.

I. The surface of the etched powder can react chemically with other components of a mixture upon curing or sintering and thus provide superior qualities to the final mixture.

The new materials may be used in current applications of FCP powders but new applications are also envisioned. The use of the new powders can substantially simplify the preparation of materials for current uses as well as their methods of use.

Examples of such replacement uses include but are not limited to:

1. Coating of metals to make items like non-stick pots and pans.

2. Making specialty inks.

3. As additives to lubricants.

4. As components of composite materials.

5. As components of mixtures for paste extrusion. In such applications the organic solvent may potentially be replaced with water at great savings.

The complimentary aspect of the use includes also an increased use of FCP powders. The reason is using a powder with hydrophilic surface will greatly reduce the initial capital needed to start an operation like coating of metals as well as decrease drastically the emission of toxic materials and wastes.

Some new potential applications which could be implemented only with hydrophilic powder include but are not limited to:

1. Making hydrophilic membranes, and,

2. Making stable ion exchangers.

The materials involved in the method of the present invention are as follows:

1. FCP micro powders made of but not limited to PTFE, PFP, PFA etc. Such polymers vary in composition, crystalinity and steric structure. Some may include also oxygen, hydrogen or other elements. The thermal history of the particles also changes their crystalline microstructure, specifically, the ratio of the crystalline to the amorphous fraction. The method disclosed can etch all fluoropolymers and all halogen-containing polymers regardless of their exact chemical composition or crystalline structure.

2. The method was applied to particles from 0.05 micron to 200 microns. Aggregates of numerous micro particles, e.g. partially sintered aggregates 6-15 microns in size of particles nominally 0.2 microns have also been etched successfully.

3. Ethers appear to be the best solvents, e.g. diglyme and tetraglyme. Other ethers and polymers based on polyethylene oxide could be used including THF, dioxane and others.

4. The etching agent is an adduct or a complex formed by mixing thoroughly sodium and naphthalene. The mixture used was a 2:1 mole of sodium to 1 mole of naphthalene. Other reagents may also be used including such based on potassium or lithium adducts or complexes with other polynuclear aromatics as ligands for complexation or electron delocalization agents.

5. The total concentration of sodium in the etching mixture was tailored to give 0.1 to 5.5% by weight.

6. The ideal surfactants should have no functional groups that can react with elementary sodium; however, such materials are not plentiful. Surfactants with an aromatic group as the oleophilic end appear to function well. Sulphonic, hydroxyl, esteric or etheric groups seem to be economically suitable for dispersing the FCP although they consume some of the reagent. Examples of preferred surfactants are dodecyl-benz-sulphonate, (DBS), and Triton® surfactants like Triton® X-114 appear to give good results. The Triton® surfactants appear to be very interesting because of their unique interaction with ethers. Ionic and non-ionic surfactants were used successfully. See also the surfactants set forth in U.S. Pat. No. 5,539,073, incorporated herein by reference.

7. All the solvents and chemicals have to be anhydrous to reduce parasitic consumption of the reagents and excess production of heat.

### EXPERIMENTAL SECTION

1. The most effective surfactant concentrations are in the range of 108 to 105 moles/m² of nominal surface area. Highly preferred concentration are around 3×10⁻⁶ molar. The operating temperature range used with diglyme was 10-85° C. but the optimal temperature appears to be about 70° C.

2. The contact time range was from 10 seconds to 15 minutes where the optimal time appears to be in the range of 2-6 minutes at 70° C.

3. Vigorous stirring is required during the micellization and the reaction steps.

4. At the end of the reaction, the reaction products are quenched by adding a protic solvent to destroy the excess sodium. The ideal solvent is methanol. Elementary hydrogen is released and the solvent cools down. The methanol helps keep the viscosity low enough to allow the particles to sediment. The majority of the solvent is decanted and the powder is washed twice with excess distilled water and then filtered.

5. The residual naphthalene may be removed by one of two methods:

Steam distillation of the naphthalene out of the powder, or,

Suspending the powder in boiling water while stirring the mixture vigorously, (about 24 hours), or also while blowing air through it, (about 4-6 hours).

About 18 g of the FCP powder, e.g. PTFE with a nominal size of 1 micron and 0.75 g of DBS are placed in a stirred reactor and heated to the desired temperature while nitrogen flows through the system.

In a separate container we preheat FSS (Flouroetch X2) until solution is homogeneous. FSS is a solution of sodium naphthalene in diglyme with sodium concentration of about 4% present as sodium naphthalene complex. The FSS is heated to 70° C. or to the desired reaction temperature.

The nitrogen flow is stopped and 500 ml of hot FSS are added to the reactor with the powder. The mixture is stirred continually while the reactor is placed under vacuum.

The solution is stirred under vacuum for the desired time, e.g. three minutes at 70° C. and then transferred into a larger container. About 50 ml of anhydrous methanol is added in a hood to quench the reaction and to destroy the excess sodium naphthalene. More methanol is added if needed until the fizzing has stopped. The mixture is stirred several times and then left to settle. The excess liquid is decanted and dionized water is added. The mixture pH is adjusted to 4 using hydrochloric or acetic acids and the powder is allowed to settle. The water is decanted and the powder is washed several times with dionized water at about 60° C. while being stirred. The excess water is decanted to provide concentrated suspension.

The wet powder may be cleaned now in one of several ways or by a combination of these methods to remove residual naphthalene. The preferred way is to start by extracting the powder with hot diglyme or a hot mixture of diglyme and methanol. After stirring the suspended powder in the hot solvent vigorously for 20 minutes, filter the hot mixture. Repeat this process three times using solvent powder ratio of 3/1. Subsequently, place the powder in dionized water and heat to boiling while mixed vigorously. One may also have clean air bubbled through it. This process may take 2 to 24 hours depending on the rate of mixing and the air flow used. The wet powder is centrifuged or filtered and dried in air.

Dry powder may be obtained by filtering the excess water and washing the powder successively by dry methanol or by dry acetone and then blowing dry air through it.

Table No. 1 describe XPS results showing the surface composition of PTFE powder obtained from three PTFE samples, two from Daikin America Inc., (Orangeburg N.Y.), and one from DuPont (Wilmington, Del.)

TABLE No. 1
Surface Composition of Unetched and Etched PTFE Micro Powder.

| Sample | F | O | C | Cl | S | Si | N |
|---|---|---|---|---|---|---|---|
| Unetched | 66.7 | <0.1 | 33.3 | | | | |
| PTFE | | | | | | | |
| Daikin L-5F | 41.1 | 7.2 | 51.5 | 0.2 | 0 | 0 | 0 |
| Daikin F-104 | 25.2 | 13.6 | 59.5 | 0.5 | 0.2 | 0.7 | 0.2 |
| DuPont MP- | 39.3 | 7.8 | 52.4 | 0.2 | <.1 | 0 | 0.2 |
| 1200 | | | | | | | |

Uses of Etched Micropowders.

Etched micro powders of PTFE may be used in making stable suspensions without adding surfactants. Such suspensions are needed for example for coatings, for specialty inks, etc. The etched powder may be added dry as a component of composites, e.g., modified rubber or other polymers where added lubrication is needed. The type of possible interaction of etched powder with components of a mixture is not exclusively physical. Since the surface of the etched powder is reactive, surface reactions will occur upon curing which will help produce more uniform composites with better properties. For example, in the case of etched fluoropolymer particles having pendant hydroxyl functionality, one could utilize such particles in a powder coating composition which utilizes hydroxyl functional polymers and, for example, blocked polyisocyanate crosslinking compounds. (See, for example, U.S. Pat. No. 5,405,920, incorporated herein by reference). Moreover, producing such mixtures in a consistent way will be easier to do and to control. Mixing etched FCP powders can greatly improve the properties of the materials even at very low concentrations while keeping the processing conditions relatively simple and low cost. Small concentrations of etched powder in lubricants can help form very high quality stable lubricant. Numerous other applications are known and many new ones are expected once such an etched powder be available commercially.

We claim:

1. A fluoropolymer particle having a diameter of from about 0.05 micron to 200 microns, said particle having pendant hydrophilic functional groups and/or pendant olefinic and/or acetylenic groups.

2. The particle of claim 1, wherein said hydrophilic functional groups are selected from the group consisting of hydroxyl, carboxyl, carbonyl, epoxy, and hydroperoxy.

3. The particle of claim 1, wherein the fluoropolymer is selected from the group consisting of poly(tetrafluoroethylene), PFP, PFA, PVDF, Tefzel, EFA fluorinated ethylene-propylene copolymers, tetrafluoroethylene, and PFA-perflouroalkoxy resin.

4. The particle of claim 1, wherein the fluoropolymer is prepared from monomers selected from the group consisting of tetrafluoroethylene, hexafluoropropene, perfluorobutene-1, perfluoroisobutene, trifluoroethylene, vinylidene fluoride, vinyl fluoride, pentafluoropropane, trifluorochloroethylene, 1,1-difluoro-2,2-dischloroethylene, 1,2-difluoro-1,2-dischloroethylene, trifluorochloroethylene, trifluorobromoethylene, and perfluoroalkoxyethylene or mixtures of these monomers.

5. The particle of claim 1, wherein the fluoropolymer is poly(tetrafluoroethylene).

6. A process for preparing a fluoropolymer particle having a diameter of from about 0.05 micron to 200 microns, wherein said polymer has pendant hydrophilic groups, which comprises contacting a fluoropolymer particle, suspended in a polar aprotic solvent, with a complex formed by the reaction of an alkali metal with a polyaromatic compound.

7. The process of claim 6, wherein the alkali metal is Na.

8. The process of claim 6, wherein the alkali metal is Li.

9. The process of claim 6, wherein the alkali metal is K.

10. The process of claim 6, wherein the polar aprotic solvent is an ether.

11. The process of claim 10, wherein the ether is selected from the group consisting of diglyme, tetraglyme, tetrahydrofuran, dioxin, diethyl ether and methyl or ethyl ethers of hydroxy-terminated poly-ethylene-oxide.

12. The process of claim 6, wherein the polyaromatic compound is selected from naphthalane, anthracene and phenanthrene.

13. The process of claim 6, wherein said particle is suspended by either application of a vacuum or the addition of a surfactant, or both.

14. The process of claim 6, wherein the surfactant is sodium bis(tridecyl) sulfosuccinnate, di(2-ethyl hexyl) sodium sulfosuccinnate, sodium dibexylsulfosuccinnate, sodium dicyclohexyl sulfosuccinnate, diamyl sodium sulfosuccinnate, sodium diisobutyl sulfosuccinnate, disodium iso-decyl sulfosuccinnate, disodium ethoxylated alcohol half ester of sulfosuccinnic acid, disodium alkyl amido polyethoxy sulfosuccinnate, tetra-sodium N-(1,2-dicarboxyethyl)-N-octadecyl sulfosuccinnamate, disodium N-octasulfosuccinnamate, sulfated ethoxylated nonylphenol, 2-amino-2-methyl-1-propanol, sodium lauryl sulfate, sodium octylphenol glycolether sulfate, sodium dodecylbenzene sulfonate, and sodium lauryldiglycol sulfate.

15. The process of claim 6, further comprising at least one of the steps of:
(a) solvent extraction;
(b) recrystalization of the naphthalene;
(c) steam distillation; or
(d) boiling an aqueous slurry of the etched particle in water while passing an inert gas through said water;
followed by isolating said fluoropolymer particle.

16. A polymer composition comprising a blend of etched fluoropolymer particles according to claim 1 and at least one other thermoplastic or thermoset polymer which is other than a fluoropolymer.

17. A polymer composition comprising a blend of etched fluoropolymer particles according to claim 1 and at least one other material which can react with the powder surface chemically upon curing or sintering.

18. The composition of claim 16, wherein said thermoplastic or thermoset polymer is selected from the group consisting of polyesters, polyurethanes, polyolefins, polyacrylates, vinyl polymers, polycarbonates, cellulose esters, peek, polyamides and polyimides.

19. A lubricating composition comprising:
(a) etched fluoropolymer particles, a fluoropolymer particle having a diameter of from about 0.05 micron to 200 microns, said particle having pendant hydrophilic functional groups and pendant olefinic and acetylenic groups; and
(b) a lubricating oil.

20. An aqueous suspension comprising:
(a) water; and
(b) fluoropolymer particles having pendant hydrophilic groups.
